(19) United States
(12) Patent Application Publication
(10) Pub. No.: US 2012/0113641 A1
(43) Pub. Date: May 10, 2012

(54) LIGHT MODULES CONNECTABLE USING HEAT PIPES

(75) Inventors: KEITH SCOTT, Livermore, CA (US); Todd Farmer, Livermore, CA (US)

(73) Assignee: BRIDGELUX, INC., Livermore, CA (US)

(21) Appl. No.: 13/290,945

(22) Filed: Nov. 7, 2011

Related U.S. Application Data
(60) Provisional application No. 61/412,315, filed on Nov. 10, 2010.

(51) Int. Cl. F21V 29/00; F21V 21/00; F28D 15/04

(52) U.S. Cl. 362/249.02; 165/104.26; 362/382

(57) ABSTRACT

An illumination apparatus includes one or more solid state light emitting sources and a radiator thermally coupled to the one or more light emitting light sources, wherein the radiator is configured to be connectable to a second apparatus. The second apparatus may be a second solid state light emitting source or a second radiator.

### CROSS REFERENCE TO RELATED APPLICATIONS

This application claims priority from U.S. provisional application Ser. No. 61/412,315, filed on Nov. 10, 2010, titled “LIGHT MODULES CONNECTABLE USING HEAT PIPES,” and is incorporated herein by reference.

### BACKGROUND

1. Field

The present disclosure relates to illumination devices. More particularly, the disclosure relates to light emitting modules formed in heat sink modules connectable using heat pipes.

2. Background

Street lights are generally designed to provide improved visibility and increased safety on the roadway while making the most efficient use of energy. The design is concerned with providing a specified level of illumination for a particular light distribution pattern. The light distribution pattern is generally classified according to its vertical and lateral distribution patterns. Often, vertical light distributions are divided into three groups, short, medium, and long based on the distance between the light source and the roadway. The Illumination Engineering Society (IES) has established a series of lateral distribution patterns designated as Types I, II, III, IV, and V for various exterior street lighting requirements. The distribution patterns of the various types relate to “footprint” (illumination pattern at the street level and level of illumination) and the height of the lamp post. Other organizations have developed different optical patterns.

Because of the intense light they produce at a high efficacy (i.e., the ratio of light produced to energy consumed, in lumens per watt), high intensity discharge (HID) lamps are commonly used for outdoor lighting and in large indoor arenas. HID lamps use an electric arc to produce intense light.

There are typically three types of HID lamps: mercury vapor, metal halide and high-pressure sodium lamps. These lamps, however, have fair to poor color rendition as compared to sunlight illumination.

Light emitting diodes (LEDs) are a form of solid state light emitting devices that are becoming preferred light sources for street lights, particularly because of their high efficiency. In addition, LEDs can be operated at much lower operational voltage. LEDs may be used individually or in arrays to provide illumination. Other forms of solid state light emitting devices are continually being developed such as, for example, organic LEDs, light emitting transistors, and the like. Such emitting devices may include only the basic structures required for light emission, such as a simple junction diode or, alternatively, they may include integrated circuitry to provided added functionality, such as trimming and stability. Solid state light emitting devices may include a single emitter or, alternatively, an array of such devices. The discussion that follows may be generalized to solid state light emitting devices, regardless of the detailed structure of a particular light emitting device.

The solid state light emitting device may be designed to maintain the same lateral light distribution pattern for different vertical light distribution pattern requirements by varying the lumen output. Preferably, the lumen output may be varied by changing the number of solid state light emitting devices used as the light source. Light sources incorporating solid state light emitting devices designed as carrier modules (or carriers) provide a convenient and efficient way to vary the lumen output for a street light.

Regardless of the solid state light emitting device considered, rejection of heat to maintain a stable operational environment may be important, since semiconductor devices may to have performance and reliability dependency on temperature. For example, light output, spectral content and lifetime may be affected by temperature. For purposes of clarity and discussion, and especially with regard to street light illumination, LEDs, and arrays thereof will be described, but are merely exemplary and do not limit the scope of solid state light emitting devices that may be considered.

Heat sinking remains as one of the challenges in designing modular solid state light sources for high luminance applications, and a solution to managing heat generation in such devices is beneficial.

### SUMMARY

In an aspect of the disclosure, an illumination apparatus includes a solid state light emitting device on a carrier module (or carrier), which may have, for example, four side faces. In one aspect of the disclosure, a radiator comprises a plurality of heat fins and heat pipes, the heat pipes extending from the heat fins. In one aspect of the disclosure, the fins are supported on the heat pipes. The heat pipes are adapted to couple to the carrier via any of the side faces.

In an aspect of the disclosure, the carrier further includes arranged plurality of holes in one or more of the side faces, wherein the holes are configured to receive at least one or more of the radiator heat pipes.

In an aspect of the disclosure, the radiator further includes one or more heat pipes attached to the array of fins. A first one or more heat pipes may extend from a first end of the array of fins of the radiator, and a second one or more heat pipes may extend from a second end of the array of fins.

In an aspect of the disclosure, carriers and radiators may be coupled to form an array of the illumination apparatus.

It is understood that other aspects of the present invention will become readily apparent to those skilled in the art from the following detailed description, wherein it is shown and described only exemplary configurations of an illumination apparatus by way of illustration. As will be realized, the present invention includes other and different aspects of an illumination apparatus and its several details are capable of modification in various other respects, all without departing from the spirit and scope of the present invention. Accordingly, the drawings and the detailed description are to be regarded as illustrative in nature and not as restrictive.

### BRIEF DESCRIPTION OF THE DRAWINGS

Various aspects of the present invention are illustrated by way of example, and not by way of limitation, in the accompanying drawings, wherein:

FIG. 1 shows a perspective view of an example of a light source in accordance with the disclosure.

FIG. 2A shows a perspective view of an example of a radiator with heat dissipation fins in accordance with the disclosure.

FIG. 2B shows a plan view of the radiator of FIG. 2.

FIG. 3 shows an example of a linear series of light sources serially connected via radiators to form an illumination system in accordance with the disclosure.

FIG. 4 shows an example of a two-dimensional arrangement of light sources connected via radiators to form an illumination system in accordance with the disclosure.

FIG. 5 shows a perspective view of an example of a radiator with heat dissipation fins and right angle heat pipes in accordance with the disclosure.

FIG. 6 shows an example of a three-dimensional arrangement of light sources connected via radiators in accordance with the disclosure.

FIG. 7 illustrates various aspects street light illumination distribution patterns.

### DETAILED DESCRIPTION

The present invention is described more fully hereinafter with reference to the accompanying drawings, in which various aspects of the present invention are shown. For purposes of this disclosure, “street light” refers to any lighting system that provides illumination to streets, roads, walkways, tunnels, parks, outdoor facilities, parking lots, and the like. A “pole” refers any structure for supporting a lighting system, including, for example, a lamp post, hi-bay, wall mounted fixture, suspended hanging fixture, and the like. A “heat sink” refers to any structure for transporting heat away from a generating source. Such structures include, for example, a thermal mass heat sink and a heat spreader, comprising a thermally conductive sheet (thick or thin) for spreading the generated heat over an extended area. “Heat pipes” refer to any conduction method used for highly efficient thermal transfer. They typically are comprised of high thermal conductivity metals or other material chambers filled with gas or liquid elements for efficient transfer of heat, and are well known in the art, e.g., copper and aluminum heat pipes and vapor chambers. This invention, however, may be embodied in many different forms and should not be construed as limited to the various aspects of the present invention presented throughout this disclosure. Rather, these aspects are provided so that this disclosure will be thorough and complete, and will fully convey the scope of the present invention to those skilled in the art. The various aspects of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method.

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element such as a structure is referred to as being coupled to another element, it can be directly connected to the other element or intervening elements may also be present. For example, one element may be electrically coupled to another by direct conductive connection, or there may be an intervening electrically conductive connector, a capacitive, inductive or other form of connection which provides for transmission of electrical current, power, signal or equivalents. Similarly, two elements may be mechanically coupled by being either directly physically connected, or intervening connecting elements may be present. It will be further understood that when an element is referred to as being “formed” on another element, it can be grown, deposited, etched, attached, connected, coupled, or otherwise prepared or fabricated on the other element or an intervening element.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements described as being on the “lower” side of other elements would then be oriented on the “upper” side of the other elements. The term “lower”, can therefore, encompass both an orientation of “lower” and “upper,” depending of the particular orientation of the apparatus. Similarly, if an apparatus in the drawing is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an” and ^{the} are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

The detailed description set forth below in connection with the appended drawings is intended as a description of various aspects of the present invention and is not intended to represent all aspects in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention.

Various aspects of an illumination apparatus will now be presented. However, as those skilled in the art will readily appreciate, these aspects may be extended to other apparatus without departing from the spirit and scope of the invention. An illumination apparatus may include a series of light sources mechanically connected serially to each other via radiators between the light sources to manage heat removal generated during operation. The radiators may include arrays of heat fins coupled to heat pipes. The light source may include a carrier supporting a light emitting device. The light emitting device may be configured with one or more light emitting sources. The heat pipes may be arranged in the radiators to enable serial or parallel coupling of radiators and light sources, either alternated or in any other combination to incorporate any selected number of light sources and radiators to eliminate waste heat while providing illumination of a specified pattern and intensity.

An example of a light emitting device is the light emitting diode (LED). The LED is well known in the art, and therefore, will only briefly be discussed to provide a complete description of the invention. An LED is a semiconductor material impregnated, or doped, with impurities. These impurities add “electrons” and “holes” to the semiconductor, which can move in the material relatively freely. Depending on the kind of impurity, a doped region of the semiconductor can have predominantly electrons or holes, which are referred to as an n-type or a p-type semiconductor region, respectively. In LED applications, the semiconductor includes an n-type semiconductor region and a p-type semiconductor region. A reverse electric field is created at the junction between the two regions, which cause the electrons and holes to move away from the junction to form an active region. When a forward voltage sufficient to overcome the reverse electric field is applied across the p-n junction, electrons and holes are forced into the active region and combine. When electrons combine with holes, they fall to lower energy levels and release energy in the form of light. In the forward biased voltage region, light output is proportional to current.

LEDs are available in a range of colors of relatively narrow bandwidth. However, in applications where it may be desirable to simulate illumination spectral properties representative of “white light” produced by incandescent, fluorescent, halogen or natural sunlight, one solution is to include one or more phosphors in a carrier encapsulating a blue LED, or as a layer above the blue LED. The phosphors absorb a portion of the short wavelength blue light and emit longer wavelengths of light—e.g., yellow, green and red—by a process called Stokes shift emission. By controlling the combination and amount of phosphors a balanced mix of light emitted by the blue LED directly and the phosphor may be perceived by the human eye as “white light.”

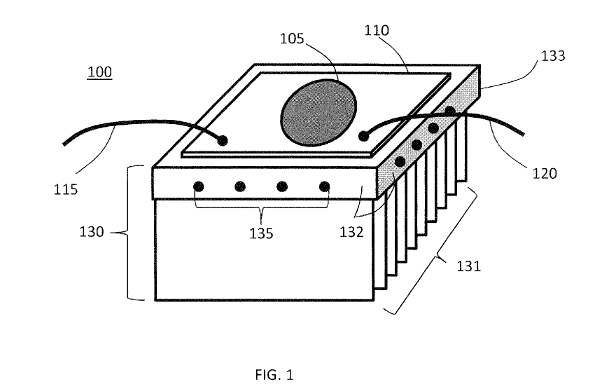

FIG. 1 shows a perspective view of an embodiment of a solid state light source 100 for holding and operating a solid state light emitting device 105. The solid state light emitting device 105 may include a single light emitting device or an array of light emitting devices on a single wafer or chip, or multiple chips. The solid state light emitting device 105 may be optionally mounted on a plate 110 which can be further attached to a carrier 130. The plate 110 may provide electrical connection to the solid state light emitting device 105. One or more wires, e.g., wires 115, 120 may be attached directly to the solid state light emitting device 105 or, as shown in FIG. 1, may be attached to the solid state light emitting device 105 via the plate 110 to excite the solid state light emitting device 105 from a power source (not shown) to emit light. The carrier 130 may include a thermal mass heat sink (or heat spreader) 133 and heat fins 131 attached to the thermal mass heat sink 133 to radiate at least a portion of waste heat generated. The heat fins 131 may be located, for example, on the underside of the carrier 130, attached to the thermal mass heat sink 133. The carrier 130 may further include holes 135 on one or more a side faces 132 of the thermal mass 133 into which may be inserted one or more heat pipes (not shown) which may be used to conduct waste heat away from the carrier 130. In one embodiment, the holes 135 may be arranged on each face 132 to align with the holes 135 on an opposite face 132. The holes 135 may penetrate only a selected distance into the carrier 130 or, alternatively, the holes 135 may penetrate through the body of the carrier 130 from one face 132 to the opposite face 132. Alternatively, axes of the holes 135 on one side face 132 may be offset from axes of the holes 135 on the opposite face 132.

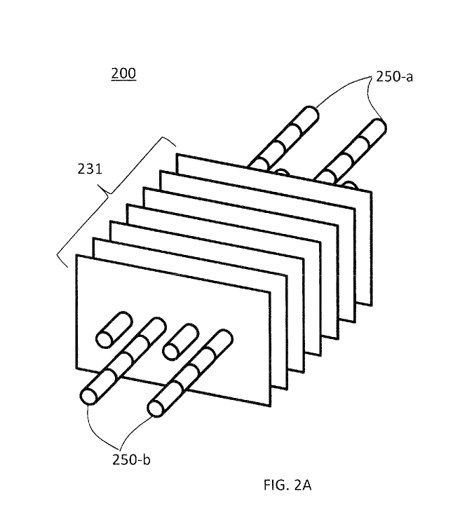

FIG. 2A shows a perspective view of a radiator 200. FIG. 2B shows a plan view of the radiator 200 of FIG. 2A. In an embodiment, the radiator 200 includes an array of parallel fins 231 for radiating heat conducted to the fins via the heat pipes 250. The heat pipes 250 typically comprise high thermal conductivity metals or other material for efficient transfer of heat, and are well known in the art. In an example, the radiator 200 includes a first one or more heat pipes 250-a extending from one side, and a second one or more of heat pipes 250-b that extend from the opposite side. In the exemplary illustration of FIGS. 2A-2B, the heat pipes 250-a and 250-b are shown as a pair of heat pipes, respectively, but there may be fewer or more heat pipes and corresponding holes. Referring to the example illustrated in FIGS. 2A-2B, the two pairs of heat pipes 250-a, 250-b may be interlaced, so that adjacent heat pipes 250 extend from opposite ends of the radiator 200. The first pair of heat pipes 250-a may be arranged to be inserted into an alternating pair of holes 135 on a first face 132 of the carrier 130.

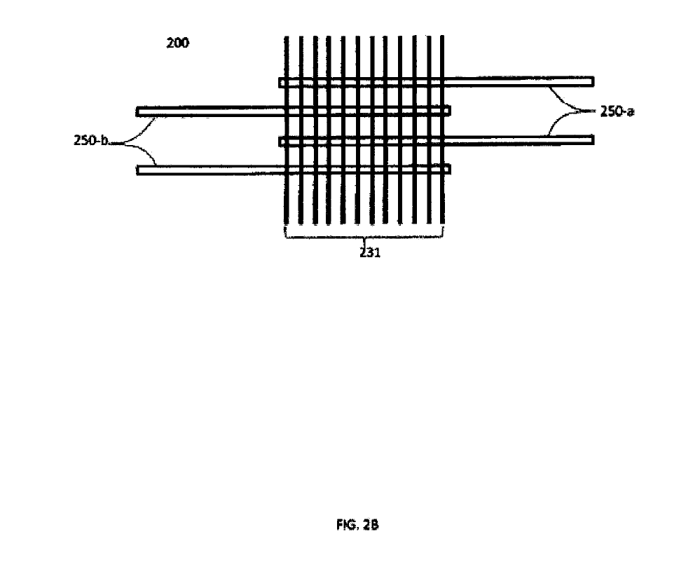

The second pair of heat pipes 250-b may be inserted into an alternating pair of holes 132 on a second carrier 130, as shown in FIG. 3. In this manner, a series of alternating radiators 200 and solid state light sources 100 may be serially connected to form an illumination system 300 of an array of solid state light sources 100 and radiators 200.

In the foregoing example, the holes 135 and heat pipes 250 are arranged in a regular, alternating pattern. Other arrangements may also be contemplated within the scope of the disclosure, including the number of holes 135 and heat pipes 250.

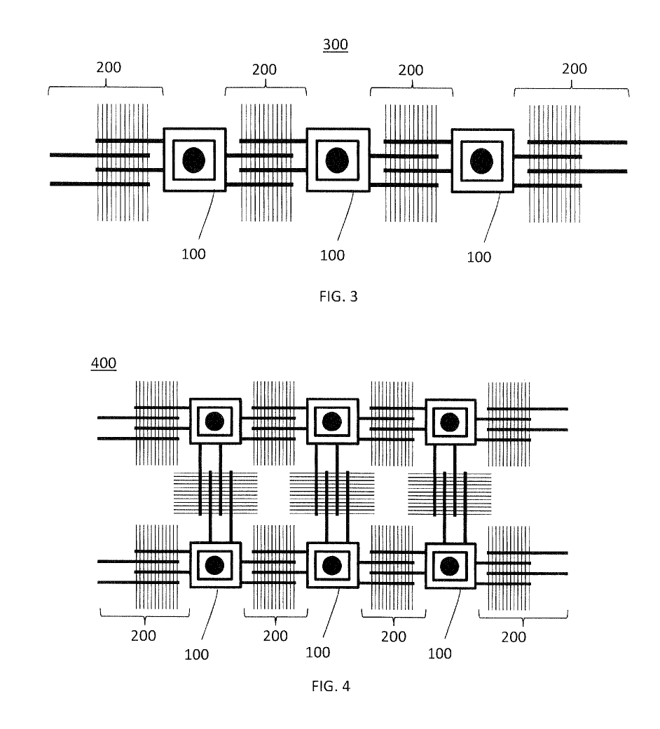

Since the holes 135 may be arranged on all four side faces 132, a two-dimensional array of solid state light sources 100 and radiators 200 may be constructed to form a larger two-dimensional (i.e., planar) illumination system 400, as shown in FIG. 4.

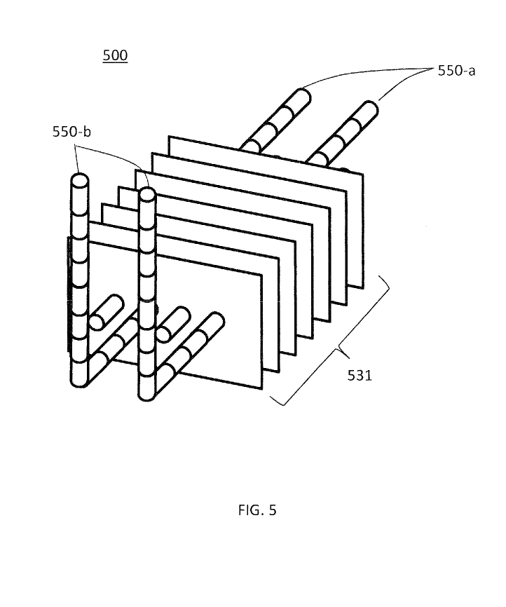

With reference to FIG. 5, in an embodiment, a radiator 500 may be formed of an array of parallel fins 531 arranged on one or more heat pipes 550. As in the example of the heat pipes 250 of FIGS. 2A-2B, two pair of heat pipes 550 may be arranged in an interlaced fashion, e.g., with a first pair of heat pipes 550-a extending from one end of the array of fins 531, and a second pair of heat pipes 550-b extending from the opposite end of the array of fins 531. In addition, at least one pair of heat pipes, for example, the second pair of heat pipes 550-b, may have the extended portions bent at an angle. For purposes of the heat pipes 550-b are illustrated as having right angles, but structural and illumination results different from those described below may be achieved with the heat pipes having any other angle. As shown, for example, in FIG. 5, the first pair of heat pipes 550-a may be straight, as shown in FIG. 5, or they may be bent at right angles, in the same manner as heat pipes 550-b. In this manner, the solid state light source 100 may project light from the solid state light emitting device 105 with the radiator 540 folded at a right angle to the solid state light source 100 to reject heat away from the solid state light emitting device 105. Up to four radiators 500 may be attached to the solid state light source 100 in the example, one at each side face 132, for more efficient removal of waste heat. As mentioned above, different angled heat pipes may be implemented to achieve different configurations for various illumination patterns.

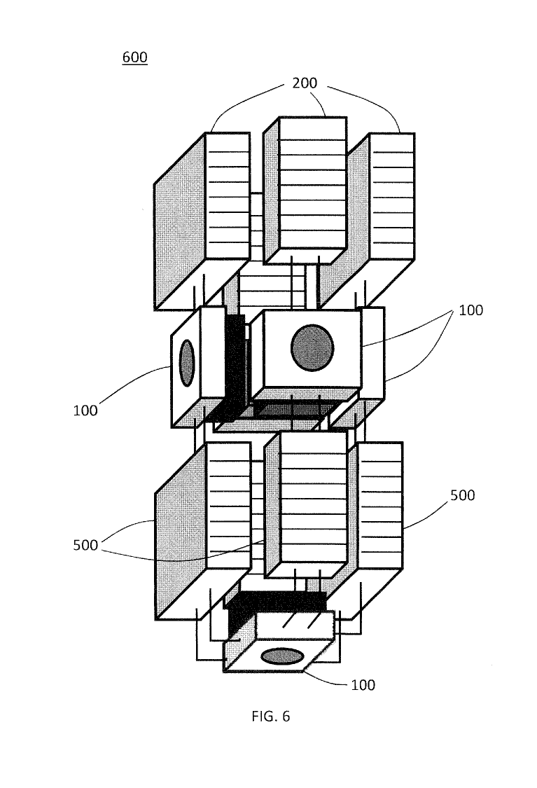

In an embodiment, as shown in FIG. 6, a quasi-hemi-spherical pattern illumination system 600 may be formed with a combination of radiators 200, radiators 500, and solid state light sources 100 with heat pipes 550-b formed with right angles. The illuminator 600 includes a solid state light source 100 facing “down” to which are coupled four radiators 500 having right angle heat pipes 550-b to arrange the fin array in an “upward” direction. Up to four such radiators 500 may be coupled to the downward facing carrier 130, one for each side face 132 of the downward facing solid state light source 100. The heat pipes 550-a from each of the radiators 500, which arc interlaced with the heat pipes 550-b, may be inserted into the solid state light sources 100, one solid state light source 100 for each radiator 500, up to four solid state light sources 100. Each solid state light source 100 may be coupled to a radiator 500 facing in an “outward” direction. Thus, the illumination system 600 projects illumination outward in a “horizontal” plane and downward. Additional radiators 200 and/or 500 may be coupled to the four horizontally projecting solid state light sources 100 on available side faces 132 for more efficient removal of waste heat.

Furthermore, the illumination system 600 may be expanded, essentially without limit, to create other configurations. In an embodiment, the illumination system 600 may be expanded in horizontally and vertically to include more vertical and/or horizontal facing solid state light sources 100 and radiators 200/500, thus providing more vertical and/or horizontal illumination.

In various embodiments, diffractive, refractive and/or diffuser optics may be arranged in front of the solid state light emitting devices 105 to provide a desired illumination pattern.

The various aspects of the present invention may have numerous applications, such as lights for roadways, parking lots, large public areas, and other outdoor applications, as well as indoor lighting applications. One example will be presented with reference to FIG. 6.

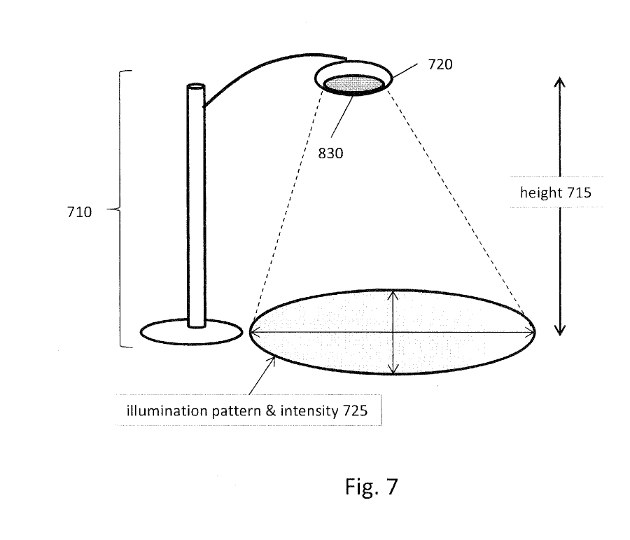

FIG. 7 is an example of an application of solid state light emitting devices to a street lamp 700. The street lamp 700 includes a lamp post 710 (including the overhanging beam), a housing head 720, in which a module is mounted, and an optical element, which may be included in the cover dome 830, or alternatively, may be included on the one or more solid state light emitting devices 100 of the illumination system 300. The optical element creates a distribution pattern from the light emitted from the plurality of solid state light emitting devices 100.

Among the characteristics that are taken into account to select an array size of the illumination system 300 and the properties of the optical element, are included the height 715 of the lamp post 710, and the illumination pattern/intensity 725 sought for the application.

The various aspects of this disclosure are provided to enable one of ordinary skill in the art to practice the present invention. Various modifications to aspects presented throughout this disclosure will be readily apparent to those skilled in the art, and the concepts disclosed herein may be extended to other apparatus. Thus, the claims are not intended to be limited to the various aspects of this disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An illumination apparatus comprising:
a solid state light source; and
a radiator thermally coupled to the solid state light source, wherein the radiator is configured to be connectable to a second apparatus.

2. The apparatus of claim 1, wherein the second apparatus comprises a second radiator.

3. The apparatus of claim 1, wherein the second apparatus comprises a second solid state light source.

4. The apparatus of claim 1, wherein the radiator comprises one or more heat pipes, wherein the one or more heat pipes provide the connectability between the radiator and the second apparatus.

5. The apparatus of claim 1, wherein the solid state light source further comprises a solid state light emitting device and a carrier thermally coupled to the solid state light emitting device.

6. The apparatus of claim 5, wherein the carrier comprises a heat sink and one or more heat fins extending from the heat sink.

7. The apparatus of claim 5, wherein the carrier comprises one or more holes, and wherein the radiator comprises one or more heat pipes extending through the one or more holes in the carrier.

8. The apparatus of claim 7, wherein the one or more heat pipes extend from a first end of the radiator, and wherein the radiator further comprises another one or more heat pipes extending from a second end of the radiator opposite the first end of the radiator, said another one or more heat pipes providing the connectability between the radiator and said another apparatus.

9. The apparatus of claim 1, further comprising a second radiator thermally coupled to the solid state light source.

10. The apparatus of claim 9, wherein the second radiator is configured to be connectable to a third apparatus.

11. The apparatus of claim 9, wherein the radiator and the second radiator are on opposite sides of the solid state light source.

12. The apparatus of claim 1, wherein the solid state light source comprises a solid state light emitting device including a phosphor and a plurality of LEDs encapsulated in the phosphor.

13. A radiator comprising:
a mast; and
one or more heat fins supported by the mast, wherein the one or more heat fins comprise one or more holes configured to receive one or more heat pipes extending from an apparatus.

14. The radiator of claim 13 wherein the one or more heat fins further comprise another one or more holes configured to receive another one or more heat pipes extending from a second apparatus.

15. The radiator of claim 14, wherein the one or more holes are located at a first end of the one or more heat fins and said another one or more holes are located at a second end of the one or more heat fins.

16. An illumination system comprising:
a plurality of solid state light emitting sources;
a plurality of radiators coupled to the plurality of solid state light emitting sources via heat pipes, wherein the coupling comprises at least one of a two-dimensional array of light sources and radiators and a three-dimensional array of light sources and radiators.
